(19) United States
(12) Patent Application Publication
(10) Pub. No.: US 2010/0177177 A1
(43) Pub. Date: Jul. 15, 2010

(54) INSPECTION OF TUBULAR-SHAPED STRUCTURES

(75) Inventors: Jeroen Jozef Sonnemans, Eindhoven (NL); Raymond Joseph Elisabeth Habets, Eindhoven (NL); Javier Olivan Bescoc, Eindhoven (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/602,923

(22) PCT Filed: Jun. 2, 2008
(86) PCT No.: PCT/IB2008/052134

§ 371 Date: Dec. 3, 2009

(30) Foreign Application Priority Data
Jun. 7, 2007 (EP) 07109821.4

(51) Int. Cl. G06K 9/00; H04N 7/18

(52) U.S. Cl. 348/61; 382/128; 348/E07.085

(57) ABSTRACT

The present invention discloses a method for inspecting tubular-shaped structures (1) within a three-dimensional (3D) image data set, e.g. a vessel in a medical image. Initially, there is provided an image data set and performed a visualization of the image data set. Then, an inspection of the image data set is performed. During the inspection the user moves a pointer (P), e.g. via a computer mouse, and a processor performs a local segmentation around the pointer so as to determine a possible shape of a tubular shaped segmented object (1), e.g. a vessel, and the processor also makes a local analysis of the segmented object. Thereafter, a screen displays a view (P1) of the segmented object (1), where the orientation of the first view is derived from the local analysis; the first view can for example be cross-sectional or longitudinal views. The invention may be used directly on the raw image data in a great diversity of visualizations. No advanced application knowledge such as anatomical models, advanced acquisition protocol settings or global segmentation is needed. It is therefore a robust method that can be used over a wide range of image modalities and anatomics, which is essential in a vascular quantification package.

### FIELD OF THE INVENTION

The present invention relates to a method for inspecting tubular-shaped structures within a three-dimensional (3D) image data set, especially a medical image data set. The invention also relates to a corresponding imaging system, and a corresponding computer program.

### BACKGROUND OF THE INVENTION

The area of medical imaging, in particular the area of multi-modality 3D vascular analysis, is achieving increased attention. Imaging tools offer advanced viewing, segmentation, inspection and quantification of vessels relevant for diagnosis for many groups of patients.

Most vendors of medical imaging workstations have a tool that supports vessel analysis, in particular 3D vascular quantification.

Although the term 3D vascular quantification sounds like it refers a single application, it actually refers to a collection of applications, which target different vascular structures using different acquisition methods, but for which the requirements for the desired measurements are equal. Anatomical examples are the aorta, the carotid arteries, the coronary arteries, the peripheral leg arteries and the coronary arteries. Magnetic resonance (MR), computational tomography (CT) and rotational X-ray are examples of used imaging modalities. Examples of vascular inspection include looking for widened or obstructed parts of a vessel or more specific search for pulmonary embolisms in the lung arteries. In any given vascular application, the main goal is to measure local vessel parameters such as area and radius at several locations in the image data to quantify the degree of stenosis or the size of an aneurism. By definition these measurements must be done on a cross-section through the vessel of interest.

For manual inspection of the vessel the user can visualize the data with a multi-planar reformat (MPR), a Maximum Intensity Projection (MIP) or a volume rendering (VR).

The desired MPR views are the cross-section view and the longitudinal view (a view aligned with the vessel). Other views that are often used for the inspection of a vessel are the curved planar and the straightened vessel views.

Most available commercial tools offer several approaches to generate the desired views:
1) Manual interaction: generation of a cross-section at a specific location using a pick-point interaction in an arbitrary visualization (MIP or VR) followed by manual rotation of a (zoomed) MPR view to obtain the correct cross section or longitudinal orientation.
2) Path drawing in order to use the path direction to orient the cross-sectional and longitudinal and curved planar or straightened views. The path drawing strategies range from completely manual to single click automatic. The quality of the resulting path depends heavily on the visualization used for interaction.
3) Manual pick point in combination with dedicated Ortho-viewers or the so-called paddle wheel views (the paddle wheel view is specific for the pulmonary embolism case).

Once a cross-section of a vessel is generated, the user can measure the vessel area by drawing a contour on this cross-section around the vessel border. If this measurement is repeated in different locations the degree of stenosis or the size of an aneurysm can be assessed. Some of the (semi) automatic path trackers also use automatic vessel border detection, and thus automatic measurements. However, in all tools the user is asked to verify the correctness of the path and the correctness of the automatically delineated vessel border.

Retrieval of the correct cross-section through a 3D object from 3D medical image on a 2D display or screen is not trivial. The required interaction for all manual methods is very tedious and prone to error. The manual definition of a path in 3D on a MPR view requires a combination of landmark placing and scrolling. The manual definition of a path on a MIP or VR image is even more difficult since the selected points do not correspond to the vessel centre but to the rendered projection coordinates (often the vessel edge) and have to be inspected (and possibly corrected) in a 2D view after path definition. When using a pick point interaction, the user must first select a location and then the user must rotate the image in 3D (or along a single axis in the so-called paddle wheel pulmonary embolism (PE) example).

This puts a serious limitation on the number of locations a user can inspect in the image given a certain amount of time. Also the manual interaction methods are prone to error since it is difficult for a user to assess if the given orientation is correct and thus results will not be reproducible. When using the pick point interaction, the user will only find out his picked point is not located inside the desired vessel after completion of the image rotation and inspection of the cross-section.

Also the single click automatic methods are cumbersome for the inspection task. The user still has to scan through the data to search for a suitable starting point for the segmentation. Then the user must wait for the segmentation and then possibly extend or edit the automatic resulting centre line before the cross sections and longitudinal views can be generated. If the segmentation result is not correct, the user must edit the result. Also the navigation along the found centre lines can be cumbersome. WO 2005/048198 (to the same applicant) discloses a method where a segmentation process is applied on a 3D image followed by a curved planar reformat (CPR). However, this reference is silent regarding the possibility that the segmentation does not find the correct vascular structure (cf. FIG. 2 of that reference). For practical applications the user will have to inspect the raw data for finding the relevant structures for further analysis and verification. This inspection is performed with the normal 3D navigation tools like scrolling, rotating zooming, panning, etc. and can be both time consuming and prone to errors.

Hence, an improved method for inspecting tubular-shaped structures would be advantageous, and in particular a more efficient and/or reliable method would be advantageous.

### SUMMARY OF THE INVENTION

Accordingly, the invention preferably seeks to mitigate, alleviate or eliminate one or more of the above mentioned disadvantages singly or in any combination. In particular, it may be seen as an object of the present invention to provide a method that solves the above mentioned problems of the prior art with inspection of tubular-shaped structures in 3D image data sets.

This object and several other objects are obtained in a first aspect of the invention by providing a method for inspecting tubular-shaped structures within a three-dimensional (3D) image data set, the method comprising:
a) providing an image data set,
b) performing a visualization of the image data set,
c) performing an inspection of the image data set, the inspection comprising
   moving a pointer,
   performing a local segmentation around the pointer so as to determine a possible shape of a segmented object,
   performing a local analysis of the segmented object, and
   displaying a first view of the segmented object, the orientation of the first view being derived from the local analysis.

The invention is particularly, but not exclusively, advantageous for obtaining a method that may be used directly on the raw image data in a great diversity of visualizations. No advanced application knowledge such as anatomical models, advanced acquisition protocol settings or global segmentation is needed. It is therefore a robust method that can be used over a wide range of image modalities and anatomies, which is essential in a vascular quantification package.

An additional advantage is the reduction in user interaction. No pick point interaction, image rotation or segmentation tasks are needed before the user knows that the selected location of the pointer result in a derived view e.g. a desired cross-section. This increases the number of locations that can be inspected in a certain amount of time.

Yet another advantage is that the invention makes measurements within a 3D image set more reproducible since views will be aligned in the same direction every time a structure, e.g. a vessel, is selected for inspection.

In connection with the present invention, segmentation is to be understood in a broad context i.e. segmentation is the process of partitioning a three-dimensional image data set into multiple regions i.e. sets of voxels. The purpose of segmentation is to simplify and/or change the representation into another representation, which is easier and/or more advantageous to analyze. Segmentation of image data set can be used for example to locate objects and boundaries. Segmentation within medical imaging is often applied for diagnostic purposes related to the quantification of stenosis, locations and volumes etc. of tumors and so forth.

In the context of the present invention, the term “view” is to be construed openly as any way or kind of visualization that can be derived from the previous local segmentation and local analysis. Thus, a view includes, but is not limited to, curved planar reformatting (CPR), curved linear views, planar views, and straitened views. Planar views can include cross-sectional views and longitudinal views.

In an embodiment, the inspection may further comprise an indication to a user that the pointer (P) is within a tubular structure for guidance during to the user. The response can be any kind of response, but the applicant has successfully used an indication around the pointer where the user's attention is already focused. As a particular example, the indication may comprise a visualization of the centroid of the segmented object. The centroid can be shown together with or instead of the pointer, e.g. a mouse pointer or similar.

In a particularly beneficial embodiment, the volume of the local segmentation is sufficiently small so as to enable displaying of the first view substantially in real-time. The term “real-time” or “realtime” is to be understood in combination with a user-interacting system having a relatively low response time between a user action and the desired system response thereto. The user may even experience that the real-time response may be experienced as an “immediate” response though this is not technically correct. More quantitatively, the local segmentation, the local analysis and the displaying of the first view (P2) may be performed within a response time being maximum approximately 100 milliseconds, more preferably 50 milliseconds, or more preferably 10 milliseconds. Possibly, response times up to 300 milliseconds may be experienced by a user as a real-time response. It should be mentioned that by linking the maximum dimension of the volume for local segmentation, the segmentation itself and the time of the analysis to provide the user with a substantially instantaneous viewing, the present invention provides a significantly improved inspection tool.

Beneficially, the inspection may further comprise displaying a second view of the segmented object, the orientation of the second view being derived from the local analysis so as to improve the user's orientation. Preferably, the first and/or the second derived view may be a cross-sectional view and/or a longitudinal view of the segmented object, respectively. In particular, the so-called ortho-viewers can be used with good results with respect to the orientation of the user.

In a cross-sectional view, the intersection of the cross-sectional view with the tubular-shaped structure may be displayed as a ring in the visualization. Thus, the ring can be shown around the structure when inside the tubular-shaped structure. Preferably, there may also be displayed one or more contours of the vessel.

Even more preferably, the indication may be displayed in the first view and/or the second view. For example, the indication can be indicated in a volume rendering or as a line in the curvilinear view of straitened reformats.

In one embodiment, the local analysis comprises a structure tensor (J) analysis which is relatively fast to apply. Additionally, Gaussian weighting or “blurring” can be applied. Another alternative could be a local vesselness filter; see A. Frangi, W. Niessen, K. L. Vincken, and M. A. Viergever, Multiscale vessel enhancement filtering. Proc. MICCAI'98, pp. 130-137, 1998.

In another embodiment, the inspection may further comprise an active selection by a user of one or more points within the tubular-shaped structure, e.g. the user clicks some points with a mouse. It should be noted that it need not the points themselves but the centered versions thereof that be applied subsequently. In particular, the one or more selected points may be chosen, directly or indirectly, as starting points for a semi-automatic segmentation process or an automatic segmentation process of at least a part of the image data set. Thus, a vessel tracking or similar analysis tool can be beneficially used in connection with this embodiment of the invention.

In yet another embodiment, the method may further comprise d) performing a structural analysis of at least a part of the image data set locally segmented and analyzed during the inspection, cf. c) above. The structural analysis may, in particular, be related to the diameter/radius of the structure, e.g. radius/diameter; local curvature, both average values and relative values. This is of special relevance for stenosis assessments and aneurism assessment. In particular, the volume of the local segmentation may be sufficiently small so as to enable accessing a result from the structural analysis d) substantially in real-time. Thus, some results relevant, e.g. for stenosis assessments and aneurism assessment, may be giving to a user at once from the structural and more exhaustive analysis. Accordingly, the inspection and analysis phase may to some extent merge together.

In a second aspect, the present invention relates to an imaging apparatus for inspecting tubular-shaped structures within a three-dimensional (3D) image data set, the apparatus comprising:
a) imaging means for providing an image data set,
b) a processor for performing a visualization of the image data set,
c) inspection means for performing an inspection of the image data set, the image apparatus further being arranged for:
   moving a pointer via a user input device,
   performing a local segmentation around the pointer so as to determine a possible shape of a segmented object,
   performing a local analysis of the segmented object, and
   displaying a first view of the segmented object, the orientation of the first view being derived from the local analysis.

The image means may be magnetic resonance (MR) imaging unit or a computational tomography (CT) imaging unit, or other suitable imaging modalities.

In a third aspect, the invention relates to a computer program product being adapted to enable a computer system comprising at least one computer having data storage means associated therewith to control an imaging apparatus according to the first aspect of the invention.

This aspect of the invention is particularly, but not exclusively, advantageous in that the present invention may be implemented by a computer program product enabling a computer system to perform the operations of the second aspect of the invention. Thus, it is contemplated that some known imaging apparatus may be changed to operate according to the present invention by installing a computer program product on a computer system controlling the said imaging apparatus. Such a computer program product may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained, by way of example only, with reference to the accompanying Figures, where

FIG. 1 shows a block diagram of an apparatus according to the present invention,

FIG. 2 shows an embodiment of a possible display view according the present invention,

FIG. 3 show a possible local analysis according to the present invention,

FIG. 4 shows a possible edge determination according to the present invention,

FIG. 5 shows scales of a local segmentation volume and a tubular-shaped structure,

FIG. 6 is a flow chart of a method according to the invention,

FIG. 7 is a more detailed flow chart of a method according to the invention,

FIG. 8 shows an application related to MR carotid of the present invention,

FIG. 9 shows an application related to CT pulmonary embolism of the present invention,

FIG. 10 shows an application related to a MR carotid artery tree of the present invention, and

FIG. 11 shows drawing of a vessel path on a MIP image by application of the present invention.

### DETAILED DESCRIPTION OF AN EMBODIMENT

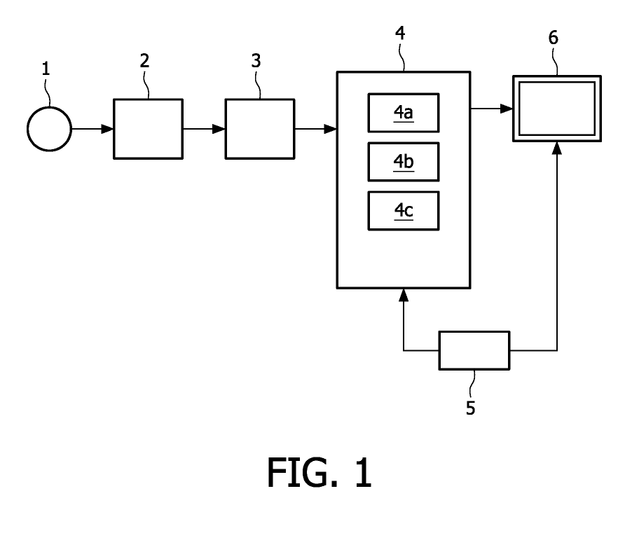

FIG. 1 shows a block diagram of an apparatus according to the present invention for imaging of an object 1. Application of a data acquisition unit 2 on the object 1, or part of the object 1, provides a three-dimensional (3D) data set. The unit 2 can be a unit arranged for magnetic resonance imaging (MRI), computed tomography (CT), ultrasound scanning, optical imaging or (3D) rotational angiography X-ray of the object.

Thus, the image data set is preferably a medical image data set, but the present invention may also be of relevance and suited for application in connection with geological analysis, material analysis, building analysis, etc. Nevertheless, in the remaining part of this description medical embodiments will be further illustrated i.e. the object 1 is a patient or part of a patient. In particular, the tubular-shaped structure investigated by the present invention can be a vessel, a bone, an airway, a colon, or a spine. In one particular embodiment, the vessel can be a lung vessel. In this case, a physician can use the views, especially the longitudinal views, but here the views are not necessarily limited to searching or showing tubular structures because a pulmonary embolism (PE) is an obstruction of the lung vessels, thus these structure may not look tubular anymore, but rather deviations from a tubular structure is searched and investigated. The data acquisition unit 2 is connected to a memory 3, e.g. a suitable storage device such as a hard disk of a computer, where the acquired 3D image set is set stored and processed by a processor 4, such as a central processing unit (CPU) of a computer which has been programmed in an appropriate way. The processor 4 comprises different parts or units for implementing the present invention.

In particular, the processor 4 comprises processing means 4a for performing a visualization of the image data set. Given a 3D image data set of e.g. a vascular structure, the user can select an arbitrary visualization like MIP, MPR, SVR or other suitable visualization readily available to the skilled person such as minimum intensity projection (mIP), Average intensity projection, iso-surface rendering, volume rendering (SVR and DVR), closest vessel projection, globe-view, polygon rendering, soap bubble, curvilinear and straightened projections.

Additionally, the processor 4 comprises processing means 4b for performing or assisting in the inspection phase. Furthermore, the processor 4 comprises processing means 4c for performing a structural analysis of the image data set locally segmented and analyzed during the inspection phase. Typically, the processing means 4c will be arranged for performing a structural analysis of the entire image data set.

The processor 4 is operably connected to the displaying screen 6, and the processor 4 is also operably connected to a user input part 5 i.e. a user input device. The user input part 5 can be a mouse, a keypad, a joystick, integrated into a touch-screen, or any other kind of device, present or future, capable of providing user-interaction to the processor 4.

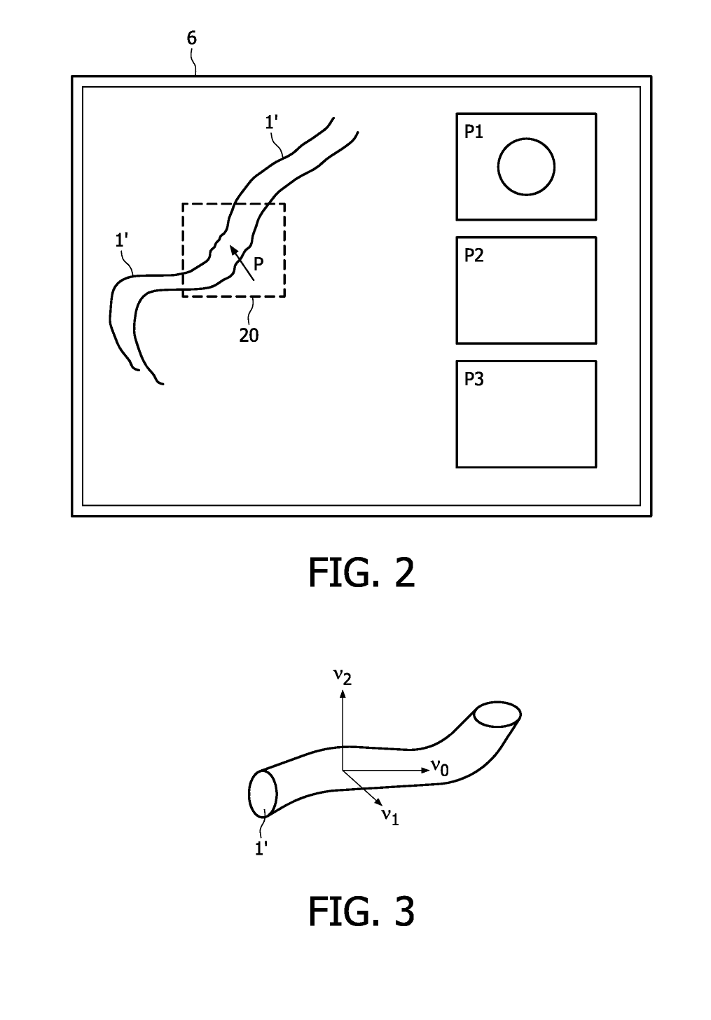

FIG. 2 shows an embodiment of a possible view as seen by a user (not shown) on the screen or display view 6, where the image data set is visualized. The user can move a pointer P around on the screen 6 and inspect a region of interest in the image data set. The pointer P has the form of an arrow but any suitable indication symbol, direct or indirect, for the pointer P can of course be applied within the teaching of the present invention.

In the embodiment of FIG. 2, a tubular-shape structure 1′, e.g. a vessel, of a patient 1 is schematically indicated. Continuously, as the user displace or hovers the pointer P around within the image data set including the structure 1′, the processor 4 performs a local segmentation around the pointer P so as to determine a possible shape of a segmented object if any. Thus, when the pointer P is displaced so that the indicated segmentation volume 20 comprises parts of the structure 1′ a segmentation of the said part of the structure 1′ will be segmented. The shown segmentation volume 20 in FIG. 2 forms a cubic square box in the medical image data set as visualized (i.e. a square form in the two dimensions of the Figure), but other geometries of the segmentation volume 20 are of course possible. The segmentation volume 20 or the segmentation “block” is determined by the size of the object 1′ under inspection, and the type of filters applied in the algorithm. For example, Gaussian functions or derivatives thereof can be applied as filter functions.

On the segmented part of the structure 1′, the processor 4b further performs a local analysis of the segmented object according to the present invention as will be further explained immediately below. As a result of the local segmentation and the local analysis, the processor 4b prompts the screen 6 to display a first view P1 of the segmented object 1′ as indicated on the right side of FIG. 2. The orientation of the first view P1 is derived from the local analysis, the first view P1 of FIG. 2 is schematically indicated as a simple cross-sectional view, but other kind of views, in particular planar views, may be derived from the local analysis. Additionally, FIG. 2 similarly shows a second view P2 and a third view P3. Typically, the second and third views can be planar views i.e. longitudinal views of the tubular-shaped structure 1′. The purpose of the views P1, P2, and P3 are to guide and support the user during the inspection phase of the medical image set.

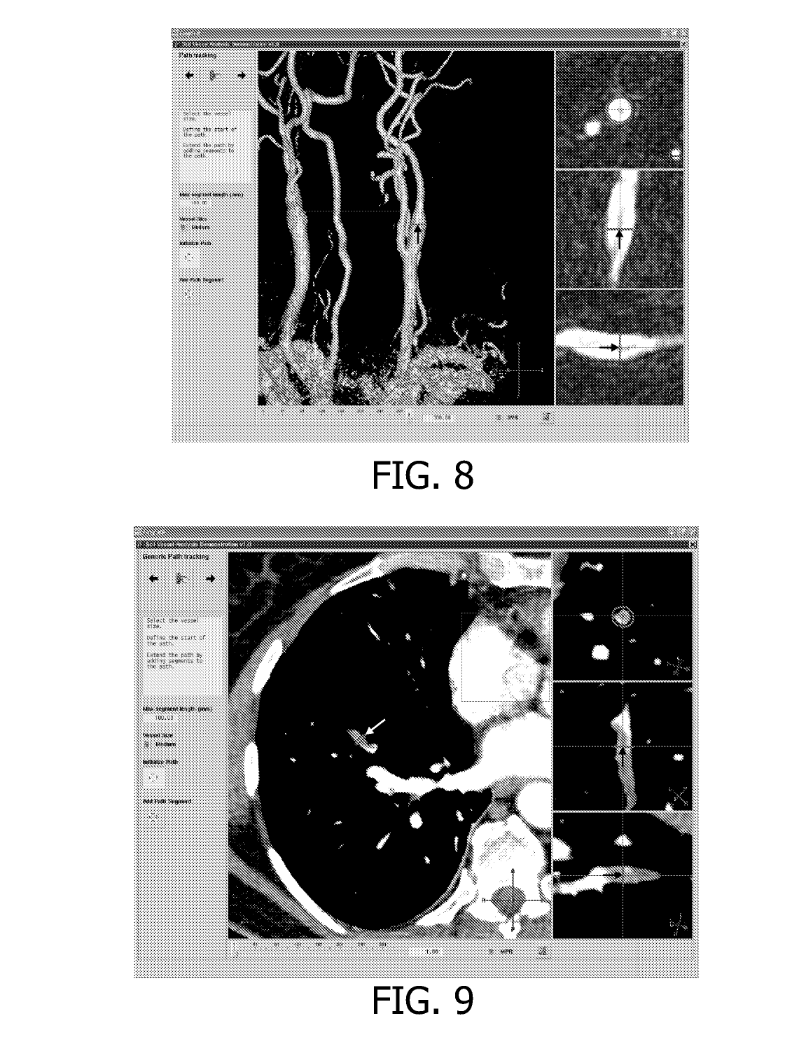

The relative arrangement of the views P1, P2, and P3, and the overall visualization of the structure 1′ can be of course be changed, but the shown configuration in FIG. 2 has shown to be helpful to users during preliminary clinical tests performed by the present applicant, cf. FIGS. 8-11.

In addition to the views shown in FIG. 2, other derived results, final or intermediate of type, can be shown in the display screen 6 or otherwise communicated to a user so as give guidance and support user during the inspection phase of the medical image set. In particular, during vascular inspection for stenosis assessment, values such as radius/diameter; local curvature, both average values and relative values can be displayed or otherwise communicated to the user e.g. by sounds.

FIG. 3 show a possible local analysis according to the present invention performed on portion of the tubular-shaped structure 1′ also shown in FIG. 2. The local analysis is performed by finding the image structure orientation by computed directly from the local image gray-scale values using the structure tensor J. The structure tensor is given by

$$J = [ \begin{matrix}〈 {g}_{x} {g}_{x} 〉 & 〈 {g}_{x} {g}_{y} 〉 & 〈 {g}_{x} {g}_{z} 〉 \\ 〈 {g}_{y} {g}_{x} 〉 & 〈 {g}_{y} {g}_{y} 〉 & 〈 {g}_{y} {g}_{z} 〉 \\ 〈 {g}_{z} {g}_{x} 〉 & 〈 {g}_{z} {g}_{y} 〉 & 〈 {g}_{z} {g}_{z} 〉\end{matrix} ]$$

Here gᵢ is the image gradient in the direction i, i can be any of the spatial coordinates x, y or z. The brackets [ ] denote a weighting over a region with a given size in mm, e.g. 1 mm, 2 mm, 3 mm, 4 mm, 5 mm, 6 mm, 7 mm, 8 mm, 9 mm, or 10 mm. In the current implementation, the weighting is implemented using Gaussian blurring. After the structure tensor has been computed, the eigenvalues {λ₀,λ₁,λ₂} and eigenvectors {ν₀,ν₁,ν₂} are computed. The eigenvalues are sorted using the convention λ₀≦λ₁≦λ₂. Therefore ν₀ corresponds to the direction in which the weighted product of the gradient is minimal. In a tubular structure 1′, this corresponds to the local vessel direction as indicated by the coordinate system shown in FIG. 3. ν₁ and ν₂ span the cross-sectional plane perpendicular to the vessel 1′ as shown in FIG. 3.

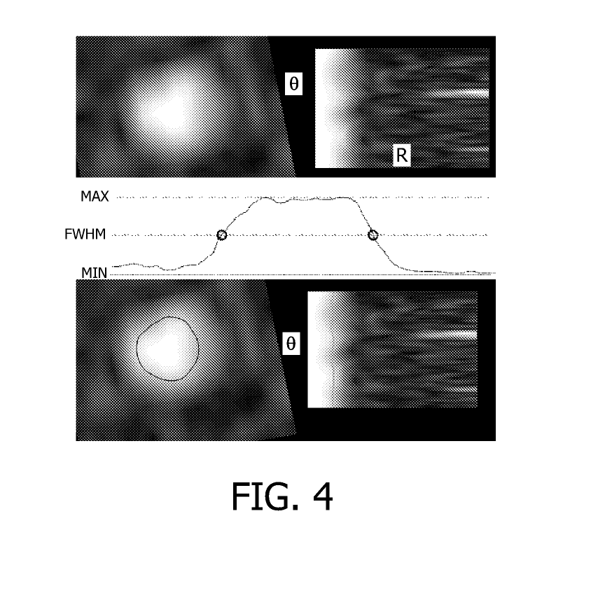

FIG. 4 shows a possible edge determination according to the present invention. The vessel contour is computed on the resulting cross-section defined by ν₁ and ν₂ (cf. FIG. 3). In the direction perpendicular to the vessel 1′, profiles are extracted along which the vessel edge is found using a basic Full Width Half Maximum (FWHM) analysis in case of MR images as shown in FIG. 4, where a polar map in R and θ coordinates (image of profiles) is extracted. For each profile, the vessel edge is found by locating the FWHM as shown in-between the upper and lower polar plots.

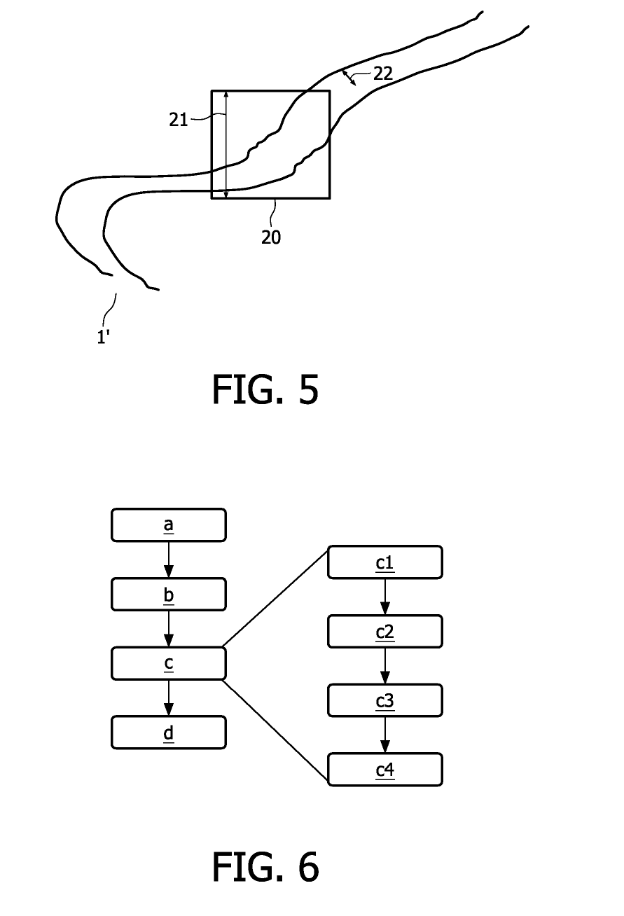

FIG. 5 shows scales of a local segmentation volume 20 and a tubular-shaped structure 1′. The segmentation volume 20 has a cubic box form with an indicated width 21, whereas the structure 1′ has an average radius 22. In order to facilitate a successful inspection of the medical image data set comprising the tubular-shaped structure 1′, it can be beneficial to adjust the segmentation width 21 relative to an expected radius value of the structure 1′. The later value is typically available to a user, at least on average, when for example a physician for example examines an identified patient. Thus, the segmentation width 21 can be K multiplied with an expected radial dimension 22 of the tubular-shaped structure 1′, K being preferably 1, more preferably 1.5, and most preferably 2. The segmentation volume e.g. the width 21 can in particular be adapted prior to, or even during, the inspection phase in order to obtain the best result from the inspection phase.

The width 21 may be any value in an interval from 1-50 millimetres (mm) depending on the segmentation performed, the local analysis, and the desired response time experienced by a user. Preferably, the width 21 is in the lower region of this interval i.e. the width may be 1, 2, 3, 4, 5, 6, 7, 8, 9, 10, 11, 12, 13, 14, 15, 16, 17, 18, 19 or 20 mm, or any interval between these values. Typically, the user will input into the processor 4, the type of contrast (object vs. background) expected for the inspection and the expected radius of the tubular-shaped object e.g. the vessel in question. In some embodiments, several filters can be applied in the same local segmentation and local analysis process, where each filter can have a different width 21.

FIG. 6 is a flow chart of a method for inspecting tubular-shaped structures 1′ (cf. FIG. 2-5) within a three-dimensional (3D) image data set. The method comprises the steps:
a) providing an image data set of an object 1,
b) performing a visualization, e.g. a MIP rendering, of the image data set,
c) performing an inspection of the image data set. The inspection comprises the sub-step:
   c1) moving a pointer P,
   c2) performing a local segmentation around the pointer P so as to determine a possible shape of a segmented object,
   c3) performing a local analysis of the segmented object, and
   c4) displaying a first view P1 of the segmented object, the orientation of the first view being derived from the local analysis.

Optionally, the method further comprises a step d) for performing a structural analysis of at least a part of the image data set locally segmented and analysed during the inspection c).

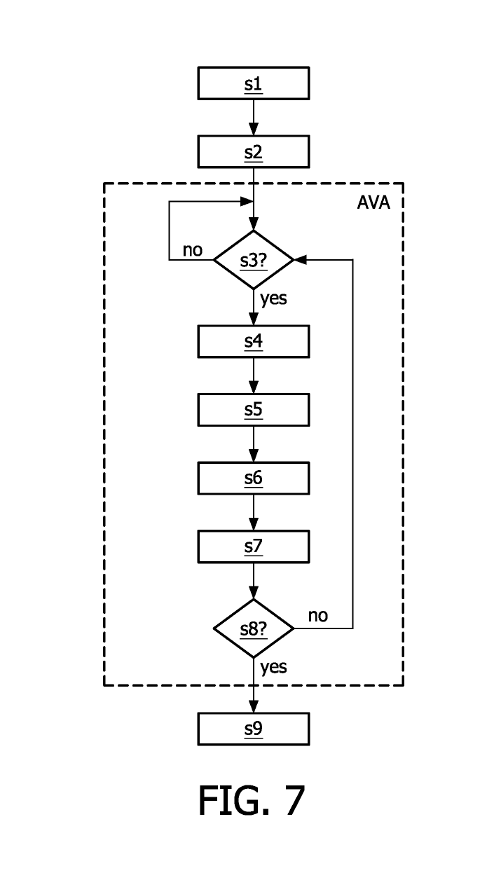

FIG. 7 is a more detailed flow chart of a method according to the invention. The step s1 corresponds to step a) above i.e. providing an image data set of an object 1, and, similarly, the step s2 corresponds to step b) above i.e. performing a visualization of the said image data set.

The step s3 is a decision step for determining whether the pointer P has been displaced, e.g. if a user has initiated a displacement via the input device 5 of FIG. 1. If negative, no further action is needed.

If positive, the method continues to step s4 where the processor 4 retrieves the current {x, y, z} pointer P or mouse location in the 3D source volume. After the position is found, local vessel orientation of the structure 1′ is found via local segmentation and local analysis in step s5. In particular, the processor 4 computes the vessel contour in given orientation in step s6, e.g. cross-sectional and longitudinal orientations. Immediately following this computation, the results can be displayed as cross-section and longitudinal so-called orthoview (using e.g. MPR), and vessel contour on given visualization may be displayed in step s7.

During decision step s8, it is determined whether the user performs an active selection f one or more points within the tubular-shaped structure 1′, e.g. by clicking on a mouse button if the input device 5 of FIG. 1 is a computer mouse controlled by a user.

If negative, the investigation phase continues back to step s3 for further investigation. The steps s3-s8 can be termed or defined as an automated vessel analysis AVA as indicated by the dashed line around these steps.

If, in step s8, the user selects some points of the image data set of particular value, the method continues to step s9. The selected points are, directly or indirectly, applied as starting points for a semi-automatic segmentation process or an automatic segmentation process of at least a part of the image data set. Thus, this embodiment of the present invention also provides an intuitive and robust way to draw a path: the centre of the cross section contour can be a ‘stable’ centreline point.

As discussed above the orientation tools i.e. the views P1, P2 and P3 work for an arbitrary visualization like MIP, MPR or volume renderings like SVR. The cross-sectional views and possibly a ring can be generated around the vessel while hovering over a vessel. On a click by a user a centreline point can be drawn. These points can also be used as starting points for (semi) automatic segmentation tools. For path drawing, the processor 4 can connect the centreline points in several ways: there can be provided a linear interpolation or feed the points as control points to a Bezier line, or one could make larger steps and determine intermediate points using a two seed point path tracking algorithm.

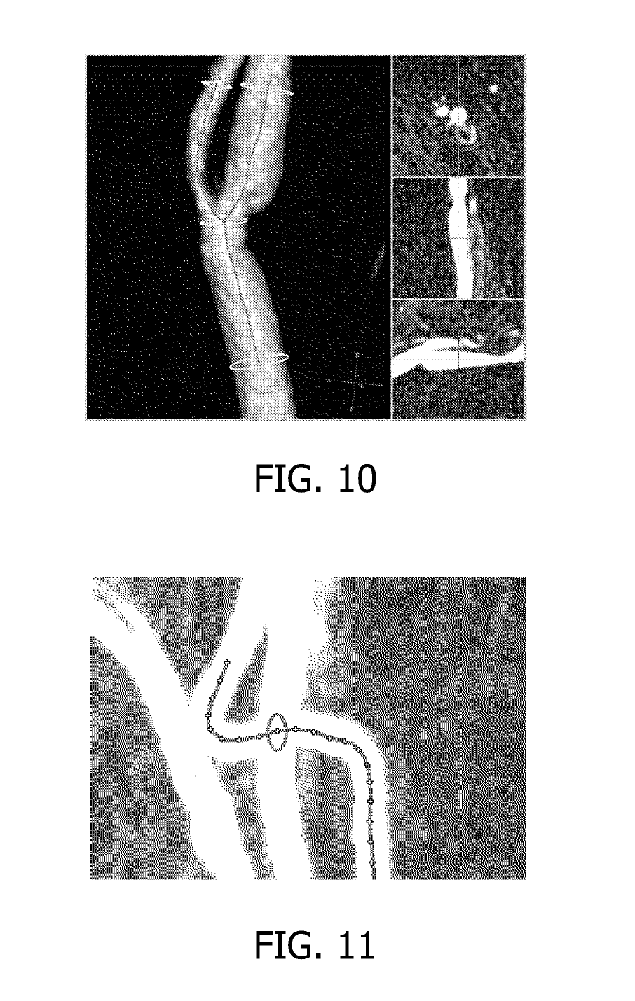

While “tracking” a vessel in a volume rendering or MIP based view the ring and the cross sections can “jump” if another vessel crosses the tracked one. If considering, the previously tracked rings and the already defined path (add some drawing/tracking history) one can make sure the tracking keeps following the same vessel. This is essential to the manual path drawing because it allows drawing a path in for instance a MIP image without constantly re-orienting the viewers. This will be further illustrated in connection with FIGS. 10 and 11.

FIG. 8 shows an application related to MR carotid of the present invention. The example shows an interface where the pointer or mouse (indicated by a bold arrow) is moved over a shaded volume rendering of an MR Carotid dataset. The orthogonal cross-sections are aligned to the local vessel direction and the detected vessel contour (ring) is displayed on all cross-sections as indicated by small arrows in the two longitudinal views on the right planar views.

FIG. 9 shows an application related to CT pulmonary embolism of the present invention. In this example, the interactive vessel inspector is demonstrated on a CTA dataset with the purpose of detection and visualizing pulmonary emboli (PE). The pointer is indicated with a white arrow, and the detected ring is indicated by small arrows in the two longitudinal views on the right planar views. For visualization of pulmonary emboli, paddlewheel visualizations have been proposed by Chiang in Detection of Pulmonary Embolism: Comparison of Paddlewheel and Coronal CT Reformations—Initial Experience, Radiology, 228: 577-582, 2003, as a tool for generating orthogonal views through the emboli. The present invention makes paddlewheel interaction obsolete because the correct orientation is found automatically, while the paddle wheel has to be rotated manually.

FIG. 10 shows an application related to a MR carotid artery tree of the present invention,

As discussed above, this method can be used to centre seed points for a (semi) automatic path tracker for in application in all modalities; and for all types of vessels. The prototype of the presented 3D vascular tool for MR coronaries and carotids is currently being validated clinically, and it can use this seed point centering. FIG. 10 shows the centered seed points and the resulting tracked paths of the common, the internal and the external carotid artery.

FIG. 11 shows drawing of a vessel path on a MIP image by application of the present invention. In this example, a path is drawn on a MIP image (part of a MR carotid contrast scan). FIG. 11 shows a situation where the vessel crosses behind another vessel. The ring will keep tracking the selected vessel (drawing was started at the lower right corner of the image). In this example, the “tracking history” of the presented drawing tool uses the direction and the depth of the already tracked path to draw across the intersection and keep tracking the correct path.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps.

Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method for inspecting tubular-shaped structures (1′) within a three-dimensional (3D) image data set, the method comprising:
a) providing an image data set,
b) performing a visualization of the image data set,
c) performing an inspection of the image data set, the inspection comprising
moving a pointer (P),
performing a local segmentation around the pointer so as to determine a possible shape of a segmented object (1′),
performing a local analysis of the segmented object, and
displaying a first view (P1) of the segmented object (1′), the orientation of the first view being derived from the local analysis.

2. The method according to claim 1, wherein the inspection further comprises an indication to a user that the pointer (P) is within a tubular structure (1′).

3. The method according to claim 2, wherein the indication comprises a visualization of the centroid of the segmented object (1′).

4. The method according to claim 1, wherein the volume (20) of the local segmentation is sufficiently small so as to enable displaying of the first view (P1) substantially in real-time.

5. The method according to claim 1 or claim 4, wherein the local segmentation, the local analysis and the displaying of the first view (P2) is performed within a response time (RespT) being maximum approximately 100 milliseconds, more preferably 50 milliseconds, or more preferably 10 milliseconds.

6. The method according to claim 1, wherein the inspection further comprising displaying a second view of the segmented object (1′), the orientation of the second view being derived from the local analysis.

7. The method according to claim 1, wherein the first (P1) and/or the second derived view (P2) is a cross-sectional view and/or a longitudinal view of the segmented object (1′), respectively.

8. The method according to claim 2, wherein the intersection of the cross-sectional view (P1) with the tubular-shaped structure (1′) is displayed as a ring in the visualization.

9. The method according to claim 2, wherein the indication is displayed in the first view (P1) and/or the second view (P2).

10. The method according to claim 1, wherein the local analysis comprises a structure tensor (J) analysis.

11. The method according to claim 1, wherein the inspection further comprises an active selection by a user of one or more points within the tubular-shaped structure (1′).

12. The method according to claim 11, where the one or more selected points are chosen, directly or indirectly, as starting points for a semi-automatic segmentation process or an automatic segmentation process of at least a part of the image data set.

13. The method according to claim 1, wherein the method further comprises:
d) performing a structural analysis of at least a part of the image data set locally segmented and analyzed during the inspection c).

14. The method according to claim 13, wherein the volume of the local segmentation is sufficiently small so as to enable accessing a result from the structural analysis d) substantially in real-time.

15. An imaging apparatus for inspecting tubular-shaped structures (1′) within a three-dimensional (3D) image data set, the apparatus comprising:
a) imaging means (2) for providing an image data set,
b) a processor (4, 4a) for performing a visualization of the image data set, c) inspection means (4, 4b, 5, 6) for performing an inspection of the image data set, the image apparatus further being arranged for:
moving a pointer (P) via a user input device (5),
performing a local segmentation around the pointer so as to determine a possible shape of a segmented object (1′),
performing a local analysis of the segmented object, and
displaying a first view (P1) of the segmented object (1′), the orientation of the first view being derived from the local analysis.

16. A computer program product being adapted to enable a computer system comprising at least one computer having data storage means associated therewith to control an imaging apparatus according to claim 1.
